(19) United States
(12) Patent Application Publication
(10) Pub. No.: US 2011/0031372 A1
(43) Pub. Date: Feb. 10, 2011

(54) FUEL CELL SYSTEM

(75) Inventors: Kazunobu Shinoda, Aichi-ken (JP); Keiji Suzumura, Aichi-ken (JP); Yasuhiro Nishiguchi, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi, Aichi (JP)

(21) Appl. No.: 12/988,462

(22) PCT Filed: Apr. 14, 2009
(86) PCT No.: PCT/JP09/57479

§ 371 Date: Oct. 18, 2010

(30) Foreign Application Priority Data
Apr. 25, 2008 (JP) 2008-115124

(51) Int. Cl. H01M 8/02; F16M 13/00

(52) U.S. Cl. 248/560

(57) ABSTRACT

It is an object of the invention to provide a fuel cell system which can reduce vibrations and noises generated upon driving of devices which are the cause of vibration.

More specifically, the base portion 100 fixed to the installation surface, support members 111 and 113 on which the devices generating vibration are attached, provided on the base portion and the vibration proofing members 112A and 112B provided between the support members and the base member are provided.

### TECHNOLOGICAL FIELD

The present invention relates to a fuel cell system provided with a vibration proofing member between a support member and a base section.

### BACKGROUND ART

In a fuel cell system for home use, as described in, for example, Patent Document 1, a box-shaped case is fixed on a base that is fixed and installed on an installation surface, and a plurality of devices constituting the fuel cell system are housed in the case.

In fuel cell systems of this type, a plurality of air pumps, water pumps and gas pumps which are the sources of vibration, are provided. These devices generate noises and vibrations when they are driven. Particularly, in the fuel cell system for home use, since the fuel cell system is installed at a position close to the house building, it is important to reduce the vibrations and noises.

### PRIOR ART DOCUMENT

### Patent Document

Patent Document 1: JP2005-32462 A

### SUMMARY OF THE INVENTION

### Problem to be Solved by the Invention

The Patent Document 1 has no considerations made to reduce the vibrations and noises.

The present invention has been made for solving the aforementioned problem in the prior art, and an object thereof is to provide a fuel cell system which can reduce the vibrations and noises generated upon driving of the devices as the vibration sources.

### Measures for Solving the Problem

In order to solve the foregoing problem, the feature of the invention according to Claim 1 resides in comprising a base section fixed on an installation surface, a support member, on which devices generating vibration are attached, provided on the base section and a vibration proofing member provided between the support member and the base section.

The feature of the invention according to Claim 2 resides in that in Claim 1, a plurality of devices generating vibration are attached on the one support member.

The feature of the invention according to Claim 3 resides in that in Claim 1, the support member comprises a stack support member on which at least the fuel cell and an auxiliary device associated therewith are attached and a reformer support member on which at least a reformer and an auxiliary device associated therewith are attached, and the vibration proofing members are provided between the stack support member and the base section and between the reformer support member and the base section.

### EFFECTS OF THE INVENTION

In the invention according to Claim 1, since the system is provided with the base section fixed on the installation surface, the support member, on which devices generating vibration are attached, provided on the base section and the vibration proofing member provided between the support member and the base section, it is possible to reduce the vibrations and noises generated by driving of the vibration generating devices.

In the invention according to Claim 2, since a plurality of devices generating vibration are attached on the one support member, it is possible to reduce the number of the vibration proofing member and thereby to reduce the cost and at the same time to facilitate the installation work of the fuel cell system.

In the invention according to Claim 3, since the support members are the stack support member on which at least the fuel cell and the auxiliary device associated therewith are attached and the reformer support member on which at least the reformer and the auxiliary device associated therewith are attached, and the vibration proofing members are provided between the stack support member and the base section and between the reformer support member and the base section, a plurality of devices which are the vibration sources can be directly attached to the stack support member and the reformer support member, respectively. This can reduce the number of the vibration proofing member.

### BRIEF DESCRIPTION OF THE DRAWINGS

FIG. 1 is a schematic view showing the outline of a fuel cell system in an embodiment according to the present invention;

FIG. 2 is a plane view of a base section of the fuel cell system.

FIG. 3 is a sectional view taken along the line 3-3 in FIG. 2.

FIG. 4 is a view as viewed in the direction of the arrow 4 in FIG. 2.

FIG. 5 is a perspective view showing a frame structure of the fuel cell system.

FIG. 6 is a cross sectional view showing a vibration proofing mount taken along the line 6-6 in FIG. 5.

FIG. 7 is an exterior view showing the external appearance of the fuel cell system.

FIG. 8 is a schematic front view showing the arrangement of devices constituting the fuel cell system, wherein a front panel portion of the outer panel is removed.

FIG. 9 is a schematic plane view in FIG. 8, wherein a ceiling panel portion of the outer panel is removed.

FIG. 10 is a schematic side view in FIG. 8, wherein a side panel portion of the outer panel is removed.

### FORM FOR PRACTICING THE INVENTION

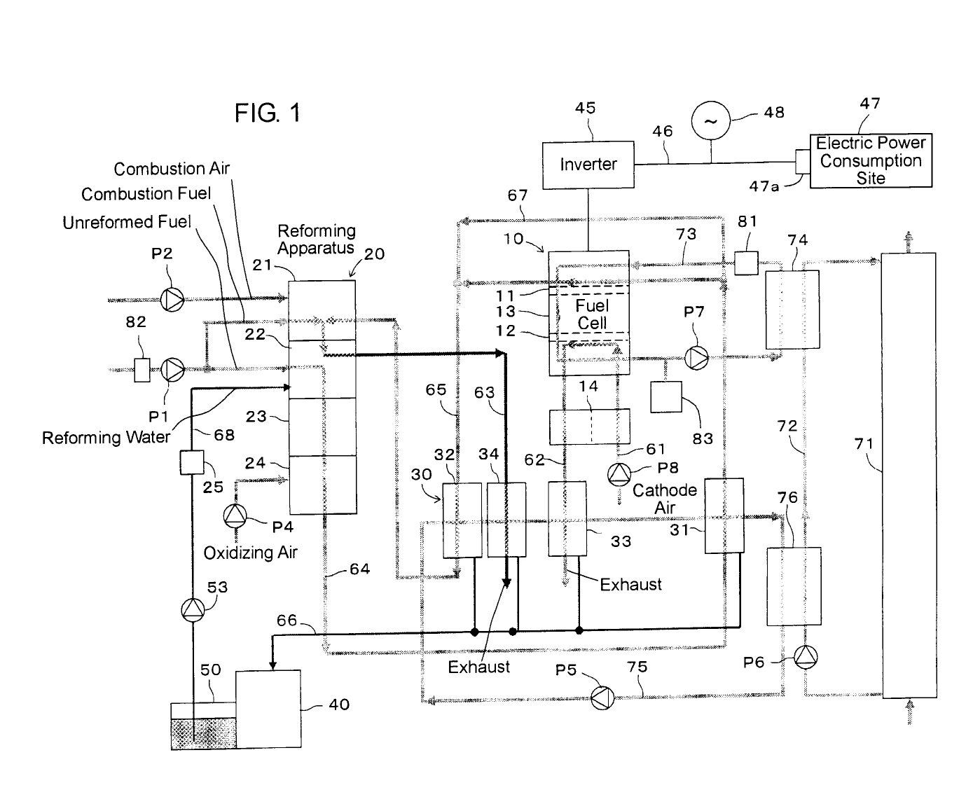

Hereafter, an embodiment of a fuel cell system according to the present invention will be described with reference to the drawings. First of all, the outline of the fuel cell system will be described with reference to FIG. 1.

In FIG. 1, the fuel cell system is provided with a fuel cell 10 and a reformer 20 for generating reformed gas (fuel gas) containing hydrogen gas necessary for the fuel cell 10. The fuel cell 10 is provided with a fuel electrode 11, an air electrode 12 as an oxidizer electrode, and electrolyte 13 (a polyelectrolyte membrane in the present embodiment) interposed between both of the electrodes 11, 12 and is operable to generate electric power by using the reformed gas supplied to the fuel electrode 11 and air (cathode air) as an oxidizer gas supplied to the air electrode 12.

The reformer 20 is the device which reforms fuel (fuel to be reformed) with steam and supplies the hydrogen-rich reformed gas to the fuel cell 10. The reformer 20 is composed of a burner (combustion section) 21 as a combustion device, a reforming section 22, a carbon monoxide shift reaction section (hereafter referred to as “CO shift section”) 23, and a carbon monoxide selective oxidation reaction section (hereafter referred to as “CO selective oxidizing section”) 24. As the fuel, there may be employed natural gas, LPG, kerosene, gasoline, methanol or the like.

The burner (combustion section) 21 is supplied with combustion fuel and burns the combustion fuel to heat the reforming section 22 with combustion gas. In other words, the burner 21 generates combustion gas which supplies heat necessary for the steam reforming reaction, by heating the reforming section 22. The combustion fuel is desulfurized by a desulfurizer 82 and is supplied by a combustion fuel pump P1 to the burner 21. The burner 21 burns combustion fuel supplied thereto with combustion air supplied by a combustion air pump P2 during a period from a starting operation to the supply starting of reformed fuel, burns reformed gas supplied directly from the CO selective oxidizing section 24 with combustion air during another period subsequent to the supply starting of reformed fuel to the starting of an ordinary operation, and during the ordinary operation, burns anode offgas (reformed gas supplied to the fuel cell but exhausted without being consumed) supplied from the fuel electrode 11 of the fuel cell 10 with combustion air to lead the combustion gas to the reforming section 22. The deficiency amount of heat in reformed gas or anode offgas is supplemented by combustion fuel. This combustion gas heats the reforming section 22 (so that a catalyzer in the reforming section 22 rises to an active temperature range therefor) and then, is exhausted outside through a combustion gas exhaust pipe 63. It is to be noted that combustible gas includes the aforementioned combustion fuel, reformed gas and anode offgas.

The reforming section 22 reforms a mixture gas in which steam (reforming water) supplied from an evaporator 25 is mixed with the unreformed fuel supplied by the combustion fuel pump P1, through the catalyzer filled in the reforming section 22 to generate hydrogen gas and carbon monoxide gas (a so-called steam reforming reaction). At the same time, the reforming section 22 metamorphoses the carbon monoxide, generated through the steam reforming reaction, and steam into hydrogen gas and carbon dioxide (a so-called carbon monoxide shift reaction). The generated gases (so-called reformed gases) are discharged to the CO shift section 23.

The CO shift section 23 reacts with the carbon monoxide and the steam included in the reformed gas through a catalyzer filled inside thereof to metamorphose them into hydrogen gas and carbon dioxide gas. Thus, reformed gas is reduced in the density of carbon monoxide to be led to the CO selective oxidizing section 24.

The CO selective oxidizing section 24 reacts with carbon monoxide remaining in the reformed gas and CO oxidation air supplied by a CO oxidizing air pump P4 through a catalyzer filled inside thereof to generate carbon dioxide. Thus, the reformed gas is further reduced in the density of carbon monoxide and is led to the fuel electrode 11 of the fuel cell 10.

The evaporator section 25 is arranged on a part of a reforming water supply pipe 68 one end of which is arranged in a reforming water tank 50 and the other end of which is connected to the reforming section 22. A reforming water pump 53 is provided on the reforming water supply pipe 68. The evaporator section 25 is heated by, e.g., the combustion gas discharged from the burner 21 (or by the waste heats from the reforming section 22, the CO shift section 23 and the like) and thus turns the reforming water fed with a pressure, into steam.

The fuel electrode 11 of the fuel cell 10 is connected at its inlet port to the CO selective oxidizing section 24 through a reformed gas supply pipe 64, and reformed gas is supplied to the fuel electrode 11. The fuel electrode 11 is connected at its outlet port to the burner 21 through an offgas supply pipe 65 and supplies anode offgas discharged from the fuel cell 10 to the burner 21. A bypass pipe 67 which bypasses the fuel cell 10 to make direct connection between the reformed gas supply pipe 64 and the offgas supply pipe 65 is provided between the reformed gas supply pipe 64 and the offgas supply pipe 65.

The air electrode 12 of the fuel cell 10 is connected to an air supply pipe 61 at its inlet port, and air (cathode air) is supplied thereinto by a cathode air supply pump P8. The air electrode 12 of the fuel cell 10 is connected to a cathode offgas exhaust pipe 62 at its outlet port, and the air (cathode offgas) form the air electrode 12 is exhausted outside.

On parts of these air supply pipe 61 and cathode offgas exhaust pipe 62, a humidifier 14 for humidifying the cathode air, supplied to the air electrode 12, by the cathode offgas being oxidizer offgas exhausted from the air electrode 12 is provided to bridge the both pipes 61, 62. The humidifier 14 is of the steam exchange type that humidifies the oxidizer gas by performing steam exchange between the cathode offgas being humidifying medium exhausted from the air electrode 12 and the cathode air being oxidizer gas, and supplies the steam in the cathode offgas exhaust pipe 62, that is, the steam in the gas exhausted form the air electrode 12 into the air supply pipe 61, that is, in the air supplied to the air electrode 12 to humidify the air.

Further, the reformed gas supply pipe 64, the offgas supply pipe 65, the cathode offgas exhaust pipe 62 and the combustion gas exhaust pipe 63 are respectively provided on the parts thereof with a reformed gas condenser 31, an anode offgas condenser 32, a cathode offgas condenser 33 and a combustion gas condenser 34. Although depicted separately in the figure, among these condensers, condensers 31-33 form a condenser 30 as a unit structure in which the condensers are integrally connected as a unit to constitute a waste heat collecting means.

The reformed gas condenser 31 condenses the steam in the reformed gas which flows through the reformed gas supply pipe 64 to be supplied to the fuel electrode 11 of the fuel cell 10. The anode offgas condenser 32 is provided on a part of the offgas supply pipe 65 which connects the fuel electrode 11 of the fuel cell 10 with the burner 21 of the reformer 20 and condenses the steam in the anode offgas which is discharged from the fuel electrode 11 of the fuel cell 11 to flow through the offgas supply pipe 65. The cathode offgas condenser 33 is provided on the cathode offgas exhaust pipe 62 and condenses the steam in the cathode offgas which is exhausted from the air electrode 12 of the fuel cell 10 to flow through the cathode offgas exhaust pipe 62. The combustion gas condenser 34 is provided on the combustion gas exhaust pipe 63 and condenses the steam in the combustion exhaust gas which is exhausted from the reforming section 22 to flow through the combustion gas exhaust pipe 63. In these condensers 31-34, the condensing refrigerant carries out heat exchanges with the respective gases which circulate through the respective condensers 31-34 which raises temperature as a result of collecting the sensible heats and the latent heats of the respective gases.

The condensers 31-34 communicate with a water refiner 40 through a pipe 66, and condensed water condensed by the respective condensers 31-34 is led to the water refiner 40 to be collected thereby. The water refiner 40 turns the condensed water supplied from the condensers 31-34, that is, the collected water into pure water through an ion exchange resin built therein and leads the purified, collected water to the reforming water tank 50. The reforming water tank 50 temporarily stores the collected water led from the water refiner 40 as reforming water. Further, the water refiner 40 is connected to a pipe for leading replenished water (tap water) supplied from a tap water supply (e.g., a water pipe) and is supplied with tap water when the quantity of the reserved water in the water refiner 40 goes down a lower limit water level.

Further, the fuel cell system is provided with a reserved hot water tank 71 for storing reserved hot water, a reserved hot water circulation circuit 72 for circulating the reserved hot water, an FC cooling water circulation circuit 73 for circulating FC cooling water exchangeable in heat with the fuel cell 10, a first heat exchanger 74 for performing heat exchange between the reserved hot water and a fuel cell heat medium, a condensing refrigerant circulation circuit 75 for circulating a heat medium (condensing refrigerant) as a liquid including the water which has collected at least the waste heat discharged from the full cell 10 and/or the waste heat generated in the reformer 20, and a second heat exchanger 76 for performing heat exchange between the reserved hot water and the condensing refrigerant.

Thus, the waste heat (thermal energy) generated by the power generation of the fuel cell 10 is collected by the FC cooling water and is then collected by the reserved hot water through the first heat exchanger 74, whereby the reserved hot water is heated (rises in temperature). Further, the waste heat (thermal energy) of the offgases (anode offgas and cathode offgas) exhausted from the fuel cell 10 and the waste heat (thermal energy) generated in the reformer 20 are collected by the condensing refrigerant through the condensers 31-34 and is then collected by the reserved hot water through the second heat exchanger 76, whereby the reserved hot water is heated (rises in temperature). The waste heat generated in the reformer 20 includes the waste heat of reformed gas, the waste heat of combustion exhaust gas form the burner 21 and the waste heat (waste heat of the reformer per se) for which heat exchange is performed with the reformer 20. “FC” in the present description and the accompanying drawings is noted as the abbreviation for “fuel cell”.

The reserved hot water tank 71 is provided with one pillar-like container, in which hot water is stored in a layered structure, that is, in such a form that the temperature is the highest on the top portion, becomes lower as the layer goes down and is the lowest at the bottom portion. Water (low temperature water) such as tap water or the like is replenished to the bottom of the pillar-like container of the reserved hot water tank 71, while the high temperature hot water stored in the reserved hot water tank 71 is led out from the top of the pillar-like container of the reserved hot water tank 71. The reserved hot water tank 71 is of a sealed type, so that it is of the type that the tap water pressure acts inside and hence, on the reserved hot water circulation circuit 72 as it is.

A reserved hot water circulating pump P6 is for drawing the reserved hot water at the bottom of the reserved hot water tank 71 to discharge the reserved hot water toward the top of the reserved hot water tank 71 by way of the reserved hot water circulation circuit 72. Thus, the reserved hot water from the reserved hot water tank 71 flows through the second heat exchanger 76 and the first heat exchanger 74 and is subjected to heat exchange with the condensing refrigerant at the second heat exchanger 76 and further to heat exchange with the FC cooling water at the first heat exchanger 74.

The FC cooling water circulating pump P7 is provided on the FC cooling water circulation circuit 73, and further, an ion resin 81 for removing unnecessary ion is also provided on the FC cooling water circulation circuit 73 and is connected to a reservoir tank 83 for replenishing cooling water.

The first heat exchanger 74 is arranged on the FC cooling water circulation circuit 73. Thus, the FC cooling water flows through the fuel cell 10, rises in temperature as a result of collecting the heat generated in the fuel cell 10, drops in temperature as a result that the heat has been collected by the reserved hot water at the first heat exchanger 74, and again flows through the fuel cell 10.

A condensing refrigerant circulating pump P5 is arranged on the condensing refrigerant circulation circuit 75. The condensing refrigerant circulating pump P5 is for circulating condensing refrigerant as a waste heat collecting heat medium in the direction of the arrow. Further, the second heat exchanger 76 is arranged on the condensing refrigerant circulation circuit 75. In addition, on the condensing refrigerant circulation circuit 75, the condensing refrigerant circulating pump P5, the anode offgas condenser 32, the combustion gas condenser 34, the cathode offgas condenser 33 and the reformed gas condenser 31 are arranged in order in a direction heading from the second heat exchanger 76 toward the downstream.

Further, the fuel cell system is provided with an inverter (electric power converter) 45. The inverter 45 is used for converting the generated power output from the fuel cell 10 into alternating-current power and for supplying the same to an electric power consumption site 47 as consumption by the end user through a power transmission cable 46. At the electric power consumption site 47, there are installed load devices (not shown) as electric appliances such as electric lights, clothes iron, TVs, washers, electric kotatsu (low table with electric heater), electric carpets, air conditioners, refrigerators and so on, and the alternating-current power supplied from the inverter 45 is supplied to the load devices on an on-demand basis. A system power source 48 of an electric power company is also connected to the power transmission cable 46 connecting the inverter 45 to the electric power consumption site 47, and when the total consumption of electric power by the load devices exceeds the generated electric power output of the fuel cell 10, the deficiency of electric power is supplemented by being received from the system power source 48. A wattmeter 47a is a user load power detection means for detecting a user load electric power (user-consumed electric power) and detects a total consumed electric power by all of the load devices used at the electric power consumption site 47, to transmits the detected electric power to a controller (not shown).

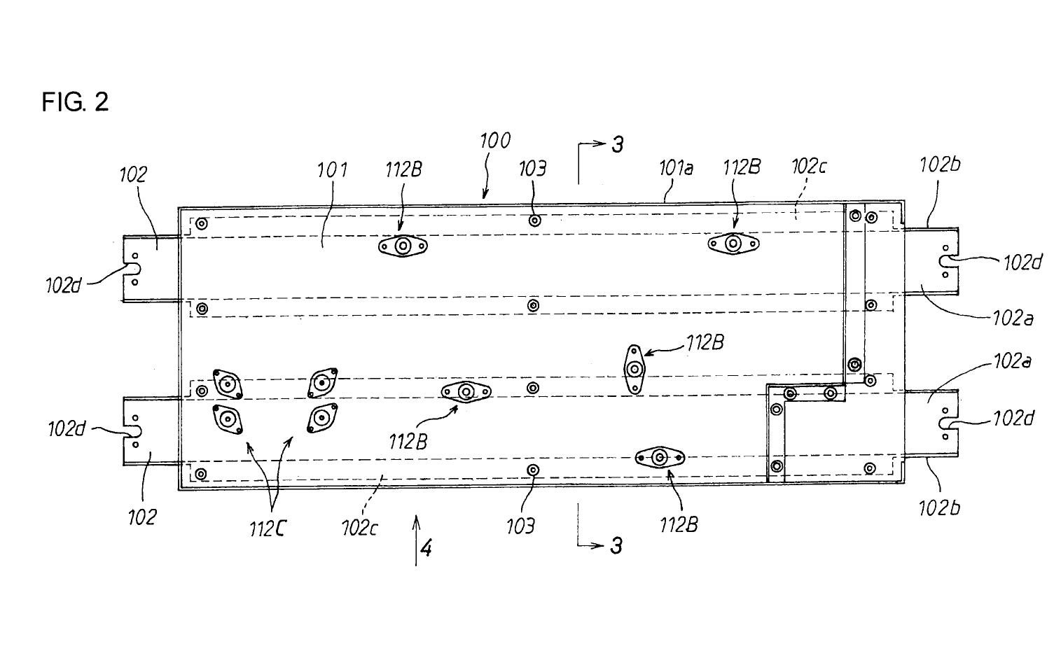

FIG. 2 shows a base section 100 of the fuel cell system and the base section 100 is composed of a base panel 101 having a generally rectangular shape and a plurality (two) of support rails 102 secured to an underneath surface of the base panel 101.

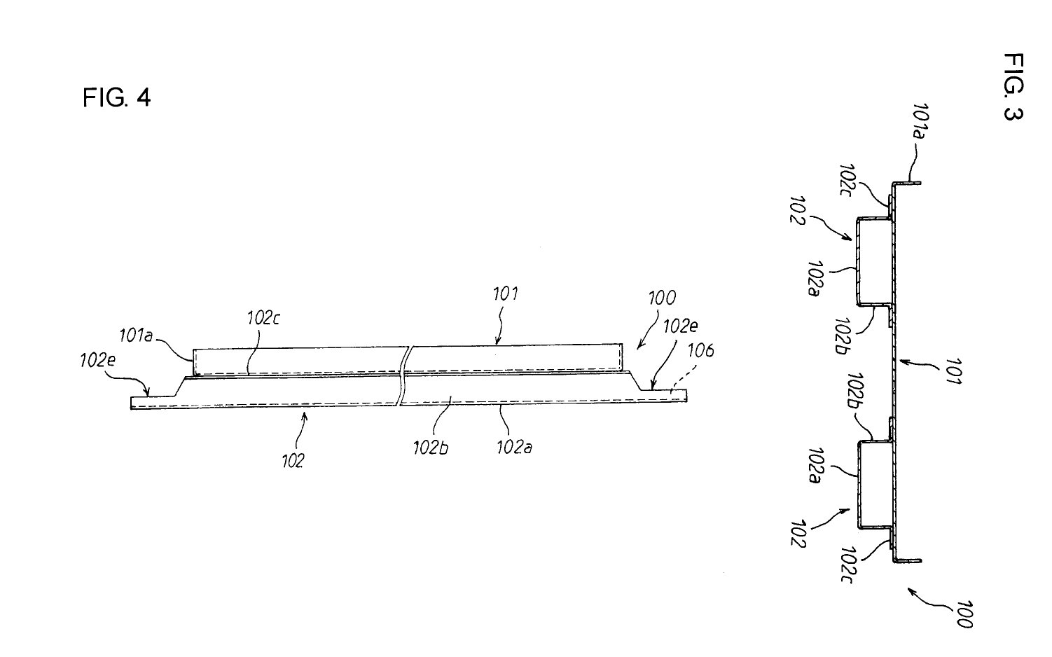

The support rails 102 extend approximately in parallel in a lengthwise direction relative to the base panel 101 and are provided with a predetermined space separated therebetween in a direction perpendicular to the lengthwise direction. As shown in FIGS. 3 and 4, each support rail 102 has a bottom wall portion 102a and opposite side wall portions 102b bent upward at a right angle or almost at a right angle from opposite end portions in the width direction of the bottom wall portion 102a, and horizontal attaching surfaces 102c which are bent at a right angle or almost at a right angle at the opposite sides in the width direction are formed at upper ends of the opposite side wall portions 102b except for opposite end portions 102e (refer to FIG. 4) in the lengthwise direction of the support rail 102.

The base panel 101 is secured by means of bolts 103 on the horizontal attaching surfaces 102c of the support rails 102. The entire length of the support rails 102 is set to be longer by a predetermined length than the longitudinal length of the base panel 101 in the lengthwise direction, and each end portion 102e in the lengthwise direction of the support rails 102 secured to the base panel 101 respectively extends outwardly from the corresponding end portion of the base panel 101. An edge portion 101a bent upward is formed at the circumference of the base panel 101.

U-shaped recess 102d is formed at each end portion 102e in a lengthwise direction of the support rails 102 for inserting an anchor bolt therethrough. The support rails 102 are mounted at the bottom wall portions 102a thereof on an installation portion (not shown) which is constituted by, e.g., a concrete foundation for installing the fuel cell system thereon, and are fixed on the installation portion by anchor bolts embedded in the installation portion.

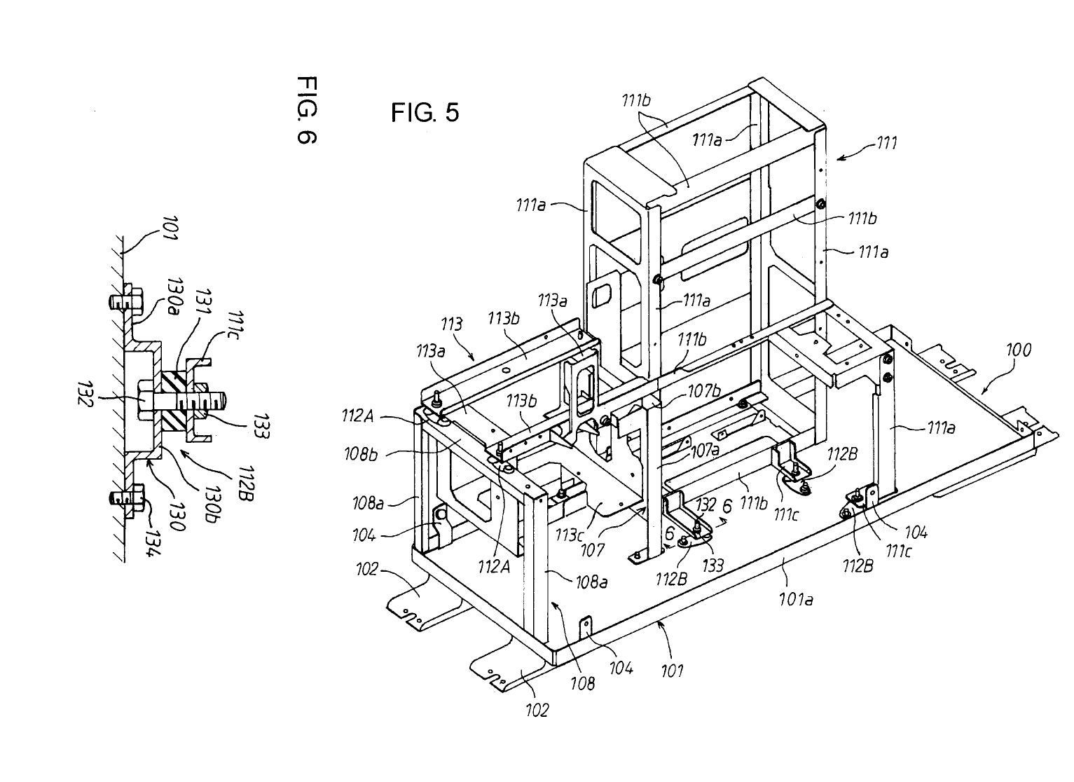

As shown in FIG. 5, on the base panel 101, a pair of support brackets 107, 108 each taking a U-shape are secured at one end in the lengthwise direction of the base panel 101 almost in parallel with a predetermined space therebetween in the lengthwise direction. Regarding the widths of these support brackets 107, 108 in the direction perpendicular to the lengthwise direction, the support bracket 107 on the right side as viewed in FIG. 5 (on the side closer to the center) is made narrower than the support bracket 108 on the left side, so that a space for installing the inverter 45 or the like can be obtained. Each support bracket 107, 108 is provided with two support frames 107a, 108a which are secured on the base panel 101 to extend vertically with a space in the direction perpendicular to the lengthwise direction of the base panel 101, and is constructed by bodily joining upper ends of these support frames 107a, 108a with horizontal cross beams 107b, 108b.

A reformer support member 113 as a support member is supported on the cross beams 107b, 108b of the support brackets 107, 108 secured on the base panel 101 through a vibration proofing mount 112A as a vibration proofing member. At least the aforementioned reformer 20 and accessories or auxiliaries associated therewith are attached on the reformer support member 113, which is made as a unit. The reformer support member 113 is provided on the support sections (support brackets) 107, 108 provided on the base panel 101, through the vibration proofing members 112A. Thus, even if the mounting position of the reformer 20 which is usually heavy in weight becomes high, the gravity center position of the reformer 20 relative to the vibration proofing mount 112A can be lowered.

Further, on the base panel 101, a stack support frame 111 as a support member is supported at the center portion in the lengthwise direction of the base panel 101 through vibration proofing mount 112B. At least the aforementioned fuel cell (stack) 10 and accessories or auxiliary devices associated therewith are attached to the stack support frame 111 to be structured as a unit.

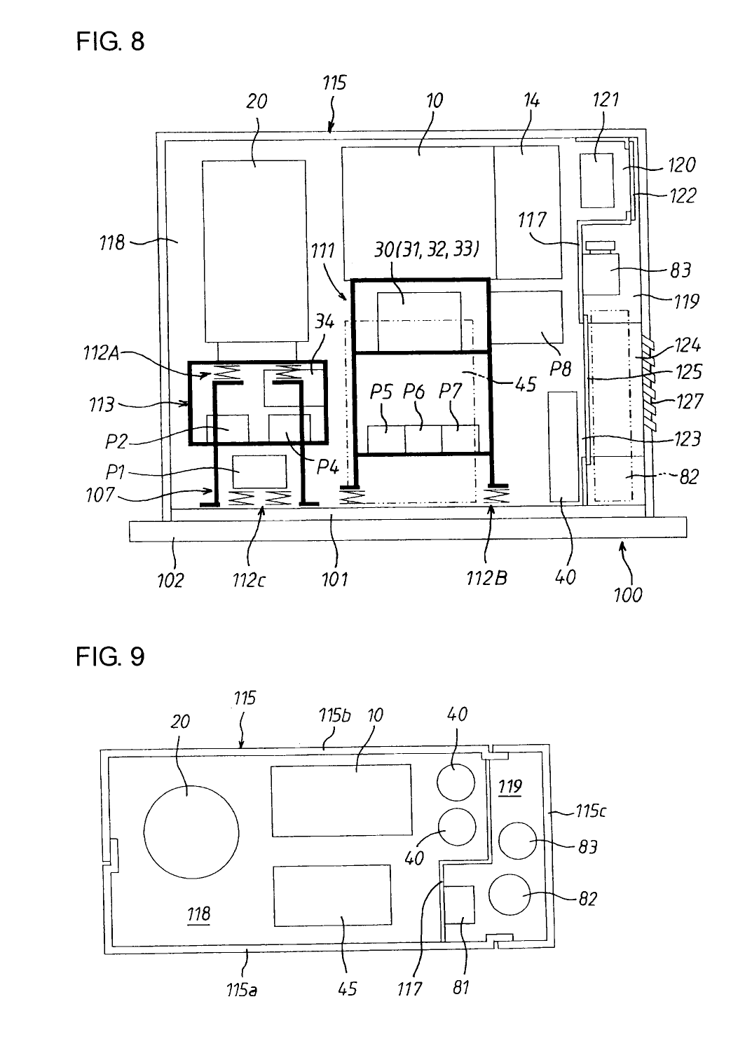

Further, as shown in FIGS. 8 and 9, on the base panel 101, the aforementioned inverter 45 is screwed to the front side of the stack support frame 111. The inverter 45 has a function to convert the direct-current voltage outputted from the fuel cell 10 into predetermined alternating-current voltage to output the same to a power line connected to the system power source 48 and another function of converting the alternating-current voltage from the power line into predetermined direct-current voltage to output the same to internal loads thereof.

In the following description, for convenience in description, the surface or near side in FIG. 5 is called as a front part of the fuel cell system, the opposite side is called as a back part, the left side in FIG. 5 is called as a left side part of the fuel cell system, and the opposite side is called as a right side part.

As shown in FIG. 5, the stack support frame 111 is constituted by a framework structure which is provided with a plurality of vertically extending support pillars 111a, a plurality of cross beams 111b reinforcing these support pillars 111a by mutually joining the same, and the like. As shown in FIG. 8, the fuel cell including the humidifier 14 is attached on an upper stage of the framework structure, the condenser 30 (31, 32, 33) is attached on a middle stage of the framework structure, and the aforementioned condensing refrigerant circulating pump P5, the reserved hot water circulating pump P6 and the FC cooling water circulating pump P7 are attached on a lower stage of the framework structure. The cathode air supply pump P8 is attached to a side surface of the framework structure.

The reformer support member 113 is provided with a pair of support frames 113a which is supported on the cross beams 107b, 108b of the pair of support brackets 107, 108 through the vibration proofing mount 112A each approximately in parallel to the cross beams 107b, 108b, a pair of connection frames 113b mutually connecting both end portions of these support frames 113a, and a U-shaped support portion 113c hanging down from these connection frames 113a. The pair of support frames 113a and the support portion 113c are bodily formed by folding a piece of plate and are formed by cutting out parts thereof and providing openings thereon for reduction of weight as well as for easiness in mounting. As shown in FIG. 8, the reformer 20 is attached on an upper stage of the reformer support member 113, the combustion air pump P2 and the CO oxidizing air pump P4 are attached on the U-shaped support portion 113c, and the condenser 34 is attached to a side surface of the support portion 113c. Further, under the reformer support member 113, the fuel pump (gas pump) P1 is arranged between the pair of support brackets 107, and the fuel pump P1 is installed on the base panel 101 through a plurality of vibration proofing mounts 112C (refer to FIG. 2).

By detaching an outer panel referred to later and by removing the inverter 45, the various devices, which are supported by the stack support frame 111 and the reformer support member 113, and the fuel pump P1 can easily be inspected and replaced from the front side of the fuel cell system without being obstructed by the cross beams, the frame bodies and the like of the stack support frame 111 and the reformer support member 113.

Since the interior of the fuel cell system becomes low in temperature at the lower part and high in temperature at the upper part, the devices attached to the stack support frame 111 and the reformer support member 113 are arranged such that the devices being low in temperature durability such as the fuel pump P1, the respective air pumps P2, P4, P8 and the respective water pumps P5, P6, P7 are arranged at the lower part in the receiving compartment, whereas the devices being high in temperature durability such as the reformer 20 or the like are arranged at the upper part of the receiving compartment.

As shown in FIG. 6, the vibration proofing mount 112B is structured by a metal attachment 130 and a vibration proofing member 131 made of rubber or the like. The metal attachment 130 includes a fixing portion 130a at each end portion and each fixing portion 130a is fixed to the base panel 101 through each bolt 134. The metal attachment 130 further includes a supporting portion 130b at the central portion and the supporting portion 130b is folded upwardly and projecting upwardly. The vibration proofing member 131 is of columnar shape and is supported on the supporting portion 130b of the metal attachment 130. A leg portion 111c fixed to the lower portion of the frame structure of the unitized stack support frame 111 is arranged on the vibration proofing member 131. A penetrating bore is provided on the supporting portion 130b of the metal attachment 130. A penetrating bore is also provided in the vibration proofing member 131 at the center thereof and another penetrating bore is provided through the leg portion 111c. A bolt 132 is inserted into the supporting portion 130b, the vibration proofing member 131 and the leg portion 111c through each penetrating bore and projected towards the upper portion of the leg portion 111c. The screw portion of the bolt 132 is screwed with a nut 133 and by this engagement with the nut, the frame structure of the stack support frame 111 is supported on the base panel 101 through the vibration proofing mount 112B, allowing the elastic deformation of the vibration proofing member 131. Similarly, the vibration proofing mounts 112A and 112C have a similar structure as the vibration proofing mount 112B.

Due to the provision of the above vibration proofing mounts 112A, 112B and 112C, the vibration and noise generated by the pumps and the like as the vibration generation source can be absorbed within the inside of the system not to transmit such vibration and noise to the outside of the system. This can prevent the transmission of vibration and noise to the inside of the house equipped with the fuel cell system.

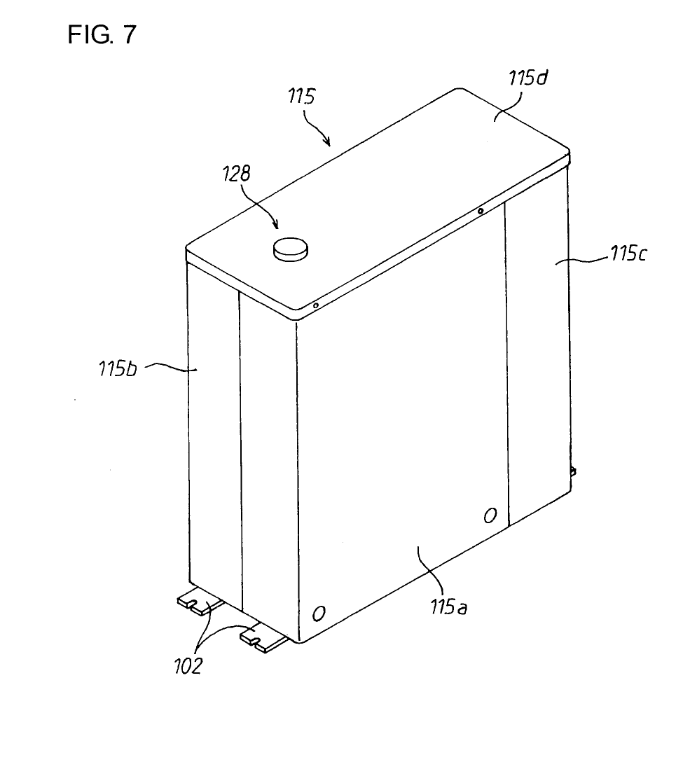

Outer panel 115 for covering the stack support frame 111, the reformer support member 113, the inverter 45 and the like is detachably attached to the base panel 101. As shown in FIGS. 7 and 9, the outer panel 115 is structured by a front panel portion 115a for mainly covering the front side portion of the fuel cell system, a back panel portion 115b for covering the back side of the system, a side panel 115c for covering the right side portion of the system and a ceiling panel portion 115d for covering the ceiling.

As shown in FIG. 9, the front panel portion 115a has an L-shape in planer view and covers the front portion and a part of the left side portion of the fuel cell system. The back panel portion 115b has an L-shape in planer view and covers the back portion and a part of the left side portion of the fuel cell system, covering the left side portion by overlapping with the front panel portion 115a. The side panel portion 115c covers an opening of the right side portion between the front and back panel portions 115a and 115b and has a reverse-C shape in planer view. The side panel portion 115c serves as a panel for maintenance which is removed when the maintenance requiring parts accommodated in a maintenance requiring parts receiving compartment, later explained in detail, are maintained. The ceiling panel portion 115d is used for closing the ceiling portion periphery of which is covered by the front, back and side panel portions 115a, 115b and 115c.

Each panel portion 115a, 115b and 115c of the outer panel 115 is fixed at the lower portion thereof to a plurality of attachment seats 104 (refer to FIG. 5) fixed to an edge portion 101a of the base panel 101a and to a partition wall 117, referred to later, by bolts or the like.

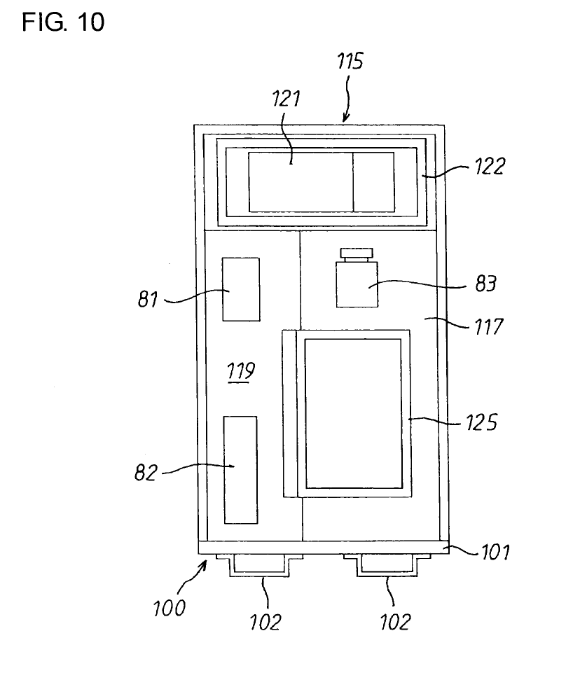

As shown in FIGS. 8, 9 and 10, on the base panel 101, the partition wall 117 is secured with a predetermined space at the right side part of the fuel cell system to extend over the front side and the back side of the fuel cell system, and the partition wall 117 partitions the interior of the outer panel 115 into a frame receiving compartment 118 for receiving the unitized support frames 111, 113 and the like and the maintenance-requiring parts receiving compartment 119 for receiving the maintenance-requiring parts of which maintenance is required at relatively short intervals. As shown in FIG. 8, an upper part of the partition wall 117 is bent toward the right side surface of the fuel cell system and constitutes an observation window 120 opening to the frame receiving compartment 118. In the inside of the observation window 120 portion, there is provided a breaker box 121 with a control board for maintenance, and the observation window 120 is closed by a detachable cap member 122 with a conventional transparent plate. By removing the cap member 122, it is possible to maintain the breaker box 121 through the observation window 120.

The ion exchanger 81, the desulfurizer 82, the reservoir tank 83 and the like as the maintenance-requiring parts are attached in the maintenance-requiring parts receiving compartment 119. Further, on the frame receiving compartment 118 side, the water refiners 40 are mounted on the base panel 101 to be adjacent to the partition wall 117. A water refiner take-out window 123 is formed on the partition wall 117, and the take-out window 123 is closed by a detachable cap member 125 which has an air filter 124 attached thereto. By removing the cap member 125, it is possible to maintain the water refiners 40 through the water refiner take-out window 123.

On the side panel portion 115c of the outer panel 115, the observation window is provided for visually inspecting the breaker box 121 from outside. Further, on the side panel portion 115c, an opening 127 with hoods for introducing the outside air is formed at a position corresponding to the air filter 124 received in the maintenance-requiring parts receiving compartment 119. The outside air (air) is introduced from the opening 127 into the fuel cell system through the air filter 124, and the introduced air is supplied to the fuel cell 10 and the interior of the inverter 45 through ducts (not shown). The air supplied into the inverter 45 is fed by the combustion air pump P2 to the burner 21, and the combustion exhaust gas is discharged outside from an exhaust port 128, formed at an upper part of the outer panel 115, by way of the combustion gas condenser 34.

The fuel cell system of the construction as described above is installed with the lengthwise direction of the base panel 101 extending along a wall of a house. At this time, the back panel portion 115b faces the wall side of the house, and the space between the back panel portion 115b and the wall is narrow. It may be the case that the space between the wall of the house and the site boundary for the house is also narrow.

In assembling the fuel cell system, first of all, the stack support frame 111 supporting the fuel cell 10 is installed on the base panel 101 through the vibration proofing members 112B. Then, the fuel pump P1 is installed on the base panel 101 through the vibration proofing mounts 112C, and the reformer support member 113 supporting the reformer 20 is installed on the support brackets 107 secured to the base panel 101, through the vibration proofing members 112A. Subsequently, the maintenance-requiring parts are attached to the outer side of the partition wall 117, and finally, the inverter 45 is secured on the base panel 101 by means of screws.

In maintaining the maintenance-requiring parts in the fuel cell system, the maintenance-requiring parts receiving compartment 119 is exposed outside only by detaching the side panel portion (panel for maintenance) 115c of the outer panel 115, so that it is possible to easily inspect or replace the maintenance-requiring parts such as the ion exchanger 81, the desulfurizer 82, the reservoir tank 83 and so on.

Further, in inspecting the devices received in the frame receiving compartment 118 of the fuel cell system, it is possible by detaching the front panel portion 115a of the outer panel 115 and, if need be, by removing the inverter 45 that the various devices, which are respectively supported by the stack support frame 111 and the reformer support member 113, and the fuel pump P1 can easily be approached without being obstructed by the cross beams, the frame bodies and the like on the base panel 101.

In the foregoing embodiment, since the support frames 111 and 113 are made as unit, it is possible to easily perform the assembling works of the fuel cell system. Further, the vibration proofing mount 112A and 112B may be provided between the support frames 111 and 113 and the base panel 101, which can reduce the number of vibration proofing mount 112A and 112B and at the same time reduce the man-power for assembling the fuel cell system.

Although in the foregoing embodiment, the stack support frame 111 for attaching the fuel cell 10 and the reformer support member 113 for attaching the reformer 20 are configured as units and these two frames 111, 113 are installed on the base panel 101, the number of the frames to be configured as units and the way of dividing the units should not be limited to those described in the foregoing embodiment.

Although in the foregoing embodiment, the vibration proofing mounts 112A, 112B and 112C are explained as the vibration proofing member, spring or damper may be used instead as long as such can prevent transmission of vibration or diminish the vibration.

Although having been described based on the embodiment as mentioned hereinabove, the prevent invention is not limited to the specific constructions described in the embodiment and may be practiced in various forms without departing from the gist of the present invention.

### INDUSTRIAL APPLICABILITY

A fuel cell system according to the present invention is suitable for use as a home use fuel cell system comprising a support member fixed to the installation surface and on which devices as the sources of vibration are attached.

### DESCRIPTION OF REFERENCE SYMBOLS

10 . . . fuel cell, 20 . . . reformer, 45 . . . inverter, 100 . . . base section, 101 . . . base panel, 102 . . . support rails, 111, 113 . . . support members (stack support frame, reformer support member), 112A, 112B, 112C . . . vibration proofing member (vibration proofing mount).

1. A fuel cell system, comprising:
a base section fixed on an installation surface;
a support member, on which devices generating vibration are attached, provided on the base section; and
a vibration proofing member provided between the support member and the base section, wherein
a plurality of the devices generating vibration are attached on the support member.

2. A fuel cell system, comprising:
a base section fixed on an installation surface;
a support member, on which devices generating vibration are attached, provided on the base section; and
a vibration proofing member provided between the support member and the base section, wherein
the support member comprises:
a stack support member on which at least a fuel cell and an auxiliary device associated therewith are attached, and
a reformer support member on which at least a reformer and an auxiliary device associated therewith are attached, and
vibration proofing members are provided between the stack support member and the base section, and between the reformer support member and the base section.

3. The fuel cell system as set forth in claim 1, wherein a plurality of support members are provided on the base section and vibration proofing members are provided between each of the support members and the base section.

4. The fuel cell system as set forth in claim 1, wherein the base section is a rectangular shaped base panel and a plurality of mutually parallel support rails fixed to an underneath surface of the base panel.

5. The fuel cell system as set forth in claim 4, wherein an entire length of the support rails is set to be longer than the longitudinal length of the base panel by a predetermined value and each end portion of the support rails extends outwardly from each corresponding end portion of the base panel in a longitudinal direction.

6. The fuel cell system as set forth in claim 2, wherein the stack support member is a frame structure comprising a plurality of support pillars extending in a vertical direction and a plurality of cross beams reinforcing the plurality of support pillars by mutually joining thereof.

7. The fuel cell system as set forth in claim 2, wherein the base section is a rectangular shaped base panel and a plurality of mutually parallel support rails fixed to an underneath surface of the base panel.

8. The fuel cell system as set forth in claim 7, wherein an entire length of the support rails is set to be longer than the longitudinal length of the base panel by a predetermined value and each end portion of the support rails extends outwardly from each corresponding end portion of the base panel in a longitudinal direction.
